(19) United States
(12) Patent Application Publication
(10) Pub. No.: US 2016/0283619 A1
(43) Pub. Date: Sep. 29, 2016

(54) SONAR-IMAGE-SIMULATION METHOD FOR IMAGE PREDICTION OF IMAGING SONAR AND APPARATUS USING THE SONAR-IMAGE-SIMULATION METHOD

(71) Applicant: POSTECH ACADEMY-INDUSTRY FOUNDATION, Gyeongsangbuk-do (KR)

(72) Inventors: Son-Cheol Yu, Gyeongsangbuk-do (KR); Hyeon Woo Cho, Gyeongsangbuk-do (KR); Han Gil Joe, Gyeongsangnam-do (KR); Jeong Hwe Gu, Daegu (KR); Ju Hyun Pyo, Gyeongsangnam-do (KR)

(21) Appl. No.: 14/678,384

(22) Filed: Apr. 3, 2015

(30) Foreign Application Priority Data
Jun. 23, 2014 (KR) 10-2014-0076702

(51) Int. Cl. G06F 17/50; G06F 17/16; G01S 15/89

(52) U.S. Cl. CPC G06F 17/5009; G01S 15/89; G06F 17/16; G06F 2217/16

(57) ABSTRACT

Disclosed herein are a sonar-image-simulation method for image prediction of an imaging sonar and an apparatus using the sonar-image-simulation method. The sonar-image-simulation method includes the models of ultrasound beams of the imaging sonar, a target object, and a background on which the target object is placed, which have been described as multiple straight lines, multiple polygons, and an infinite plane, respectively. The method also includes calculating intersection points of the multiple straight lines with the multiple polygons or the infinite plane to derive image data needed to construct simulated sonar images. Based on the computed image data, the method can construct the simulated sonar images of any arbitrary-shaped object.

### CROSS-REFERENCE TO RELATED PATENT APPLICATIONS

This patent application claims priority to Korean Application No. 10-2014-0076702, filed Jun. 23, 2014, the entire teachings and disclosure of which are incorporated herein by reference thereto.

### BACKGROUND OF THE INVENTION

1. Field of the Invention

The present invention relates to a sonar-image-simulation method for image prediction of an imaging sonar and an apparatus that uses the sonar-image-simulation method.

2. Description of the Related Art

Generally, underwater object recognition has great potential for automatic object detection, environment monitoring, and safety inspection and maintenance of underwater structure. Additionally, for example, it is applicable to underwater mine tracking via autonomous underwater vehicles. Although underwater optical sensors for this end provide the highest-resolution underwater images, their visibility is generally limited due to turbidity of the water. Compared to optical vision, imaging sonar, which uses acoustic signals to visualize underwater environments, has a long visual range even in turbid water and thus it is treated as an alternative approach for underwater object recognition.

However, a display mechanism of the imaging sonar is completely different from that of optical cameras, which is generally described by a pinhole model. Imaging sonar generates a sonar image by measuring a distance and reflective acoustic signal from a target object. That is, even an object with a well-known size and shape may appear quite different from an intuitively predicted shape in the sonar image. Moreover, the shape of an object in the image may vary completely even with a small change in the view point.

With considering the aforementioned points, if the sonar image of an object to be detected is known in advance, the detection may become reliable to perform. Therefore, a simulator for advance prediction of sonar images is needed.

### SUMMARY OF THE INVENTION

Accordingly, the present invention has been made keeping in mind the above problems occurring in the prior art. The object of the present invention is to provide a sonar-image-simulation method for image prediction of an imaging sonar to predict a sonar image of a target object and an apparatus using the sonar-image-simulation method.

In order to accomplish the above object, the present invention provides a sonar-image-simulation method for image prediction of an imaging sonar, in which it sets a model of ultrasound beams of the imaging sonar, a model of a target object, and a model of the background on which the target object is placed as multiple straight lines, multiple polygons, and an infinite plane, respectively. These models are just elementary geometry that can be easily stated by mathematical equations. The sonar-image-simulation method simulates image data by calculating intersection points of the multiple straight lines representing the ultrasound beams with the multiple polygons representing the target object or the infinite plane, and deriving image data based on the calculated intersection points to construct a simulated sonar image.

The setting may include a first setting operation that sets a total number of the straight lines and their directions as the parameters of the ultrasound beam model and a position and an orientation of the imaging sonar and a second setting operation that sets multiple polygon meshes as the parameters of the target object model.

In the second setting operation, the polygons' shape may be a triangle.

The setting may include receiving parameters of the model of the target object in the form of a computer-aided design (CAD) file.

The simulating may include transforming coordinates of the multiple polygons from a global coordinate system to a local coordinate system, calculating the intersection points of the multiple straight lines and the coordinate-transformed multiple polygons or the infinite plane, and the image data depending on a position of the calculated intersection points in the local coordinate system.

The intersection points may include determining whether the intersection points are inside the polygon area being examined.

The image data may include calculating the intersection point's absolute distance r, and each straight line's an azimuth angle θ.

The calculating the image data may include selecting a straight line having the higher intensity between two straight lines if the two straight lines have the same distance and azimuth angle but different elevation angle.

The calculating the image data may include selecting a intersection point having a smallest distance among two or more intersection points if the two or more intersection points are calculated on one straight line.

The calculating the image data may include determining an intensity corresponding to the intersection points according to the type of an object which the straight line meets.

The calculating the image data may include determining the intensity to be highest if the straight lines meet the polygons, to be lowest if the straight lines meet neither the polygons nor the infinite plane, and to be intermediate if the straight lines meet the infinite plane.

The image-prediction simulation method may include displaying the simulated sonar image.

The present invention also provides an image-prediction simulation apparatus executing the image-prediction simulation method described above.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic block diagram illustrating a sonar-image-simulation apparatus for image prediction of an imaging sonar according to an embodiment of the present invention.

FIGS. 2A and 2B are conceptual diagrams describing the model of ultrasound beams of an imaging sonar with lines along the elevation angle φ and lines along the elevation angle φ, respectively.

FIG. 3 is a conceptual diagram describing an ultrasound beam of an imaging sonar as an approximated but original form.

FIG. 4 is a diagram describing the way a straight line is defined in the imaging sonar coordinate system.

FIG. 5 is a conceptual diagram describing a polygon model of a target object.

FIG. 6 is a conceptual diagram describing the display mechanism of an imaging sonar.

FIGS. 7A through 7C are diagrams illustrating how to choose three vectors to determine whether the intersection point lies in the polygon area.

FIGS. 8A and 8B are diagrams illustrating original sonar image form and the transformed sector form.

FIG. 9 is a flowchart illustrating a sonar-image-simulation method for image prediction of an imaging sonar according to an embodiment of the present invention.

FIG. 10 shows pictures of an exemplary target object used in a sonar-image-simulation method for image prediction of an imaging sonar according to an embodiment of the present invention.

FIGS. 11A and 11B are diagrams illustrating sonar images of the object in FIG. 10 and its corresponding simulated images.

### DESCRIPTION OF THE PREFERRED EMBODIMENTS

Hereinafter, embodiments of the present invention will be described in detail with reference to the attached drawings to allow those of ordinary skill in the art to easily carry out the embodiments. The present invention may be implemented in various forms, without being limited to the embodiments described herein. In the drawings, parts that are not relevant to a description of the present invention will not be provided for clarity, and the same reference numerals are used throughout the different drawings to designate the same or similar components.

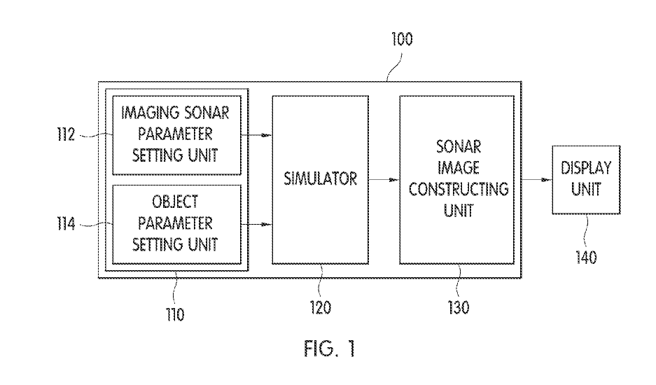

FIG. 1 is a schematic block diagram illustrating a sonar-image-simulation apparatus for image prediction of an imaging sonar according to an embodiment of the present invention. In the following description, the apparatus will be described in detail with reference to the drawings.

Referring to FIG. 1, sonar-image-simulation apparatus 100 for image prediction of an imaging sonar according to an embodiment of the present invention may include a parameter setting unit 110, a simulator 120, and a sonar image constructing unit 130.

Parameter setting unit 110 sets parameters of the ultrasound beam model of the imaging sonar, parameters of the target object model, and those of the background model. Parameter setting unit 110 may include imaging sonar parameter setting unit 112 and object parameter setting unit 114.

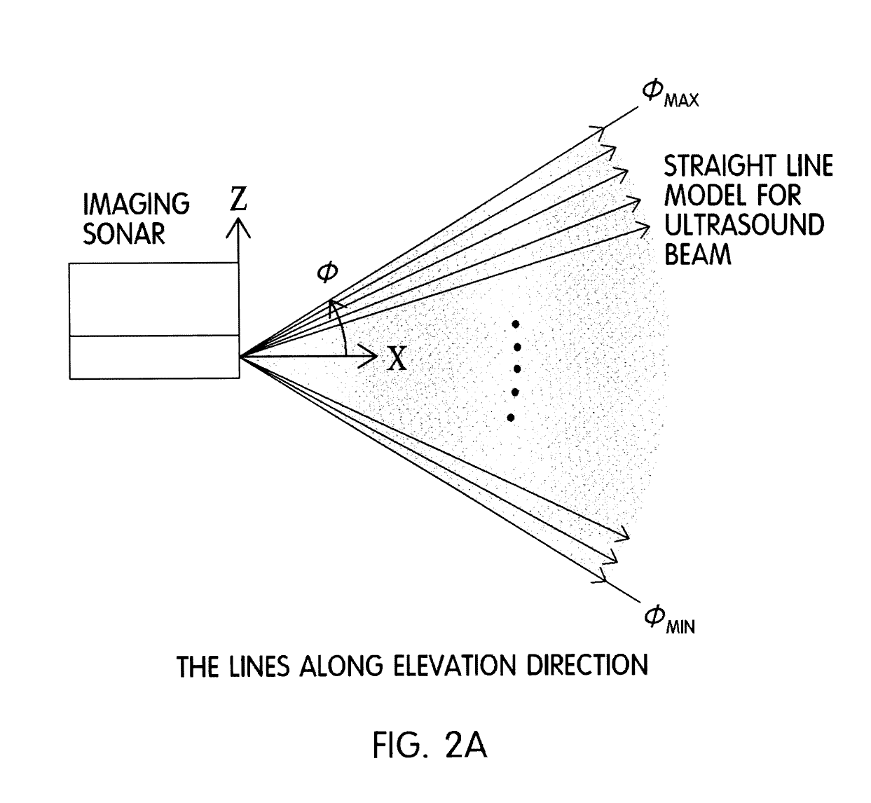

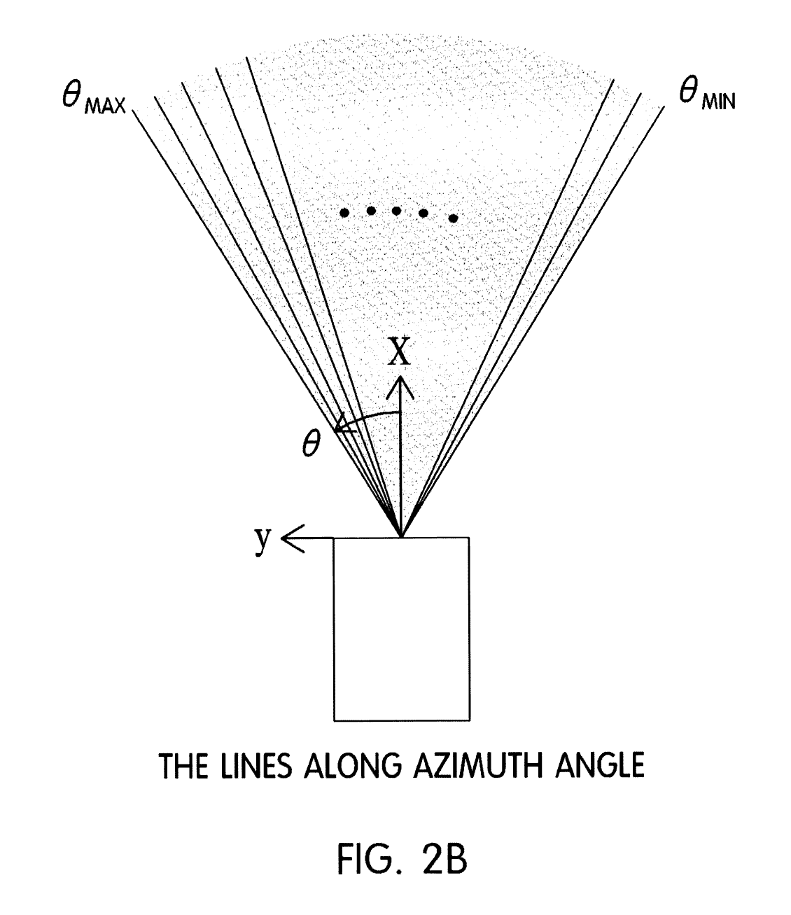

More specifically, imaging sonar parameter setting unit 112 sets the total number of straight lines and their directions representing the ultrasound beams and a position and orientation of the imaging sonar. In the imaging sonar, the ultrasound beams are emitted in the form of a nearly-planar beam as illustrated in FIGS. 2A and 2B, which may be expressed as a set of many straight lines.

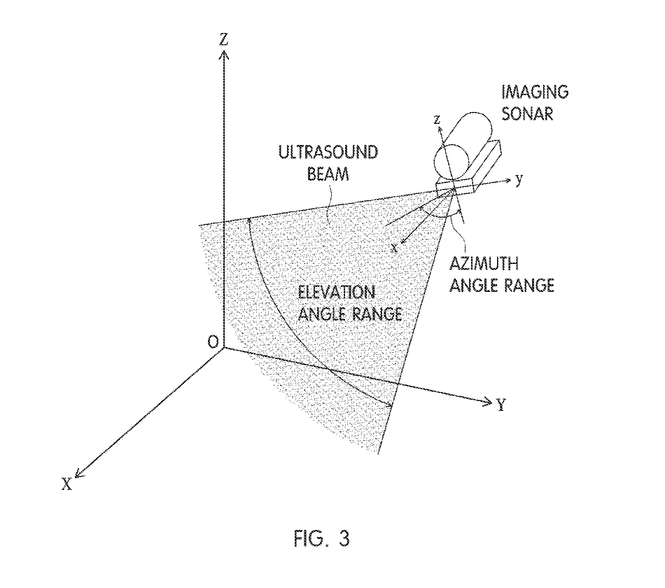

FIGS. 2A and 2B are conceptual diagrams describing the model of ultrasound beams of an imaging sonar, FIG. 3 is a conceptual diagram describing an original ultrasound beam of the imaging sonar in the form of a vertical plane, and FIG. 4 is a diagram describing the way a straight line is defined in the imaging sonar coordinate system.

As illustrated in FIG. 3, the ultrasound beam is originally close to a vertical plane that proceeds in a fan shape. This plane sweeps rapidly from side to side within a certain range (azimuth range). In this way, the imaging sonar may cover a certain range of area in the forward direction. Since many straight lines can approximate a plane as in FIGS. 2A and 2B, an ultrasound beam may be considered as a set of multiple straight lines.

In FIG. 4, a straight line indicating the part of the ultrasound beam is defined with an elevation angle φ and an azimuth angle θ in the imaging sonar (local) coordinate system. For example, the elevation angle φ and the azimuth angle θ may range from −15° to 15°, and 1000 straight lines may be assumed along the elevation angle φ and 96 lines along the azimuth angle θ as illustrated in FIGS. 2A and 2B.

An equation of each straight line may be defined in the local coordinate system, as follows:

$${p}^{->} = t {v}^{->} ; ( t \geq 0 ) or \\ [ \begin{matrix}{p}_{x} \\ {p}_{y} \\ {p}_{z}\end{matrix} ] = t [ \begin{matrix}cos ϕ cos θ \\ cos ϕ sin θ \\ sin ϕ\end{matrix} ] ,$$

where p represents an arbitrary point on the straight line, and \vec{v} represents a normalized direction vector. The origin of the coordinate system is considered as a source of beams.

Referring back to FIG. 1, object parameter setting unit 114 sets multiple polygon meshes as the parameters of the target object, and in this case, the polygons describing the surface of the object may have a triangle shape. In this way, any arbitrary-shaped object can be made.

Each polygon can be defined as an equation of plane with boundary which is simple to manipulate. For example, a triangular polygon needs three points for itself to be defined. The plane of a polygon implies a part of the plane passing those three points, and its boundary is defined by the lines connecting the points. Therefore, instead of dealing with complex surface equation of objects, we can simplify the necessary computation by using polygons' plane equations.

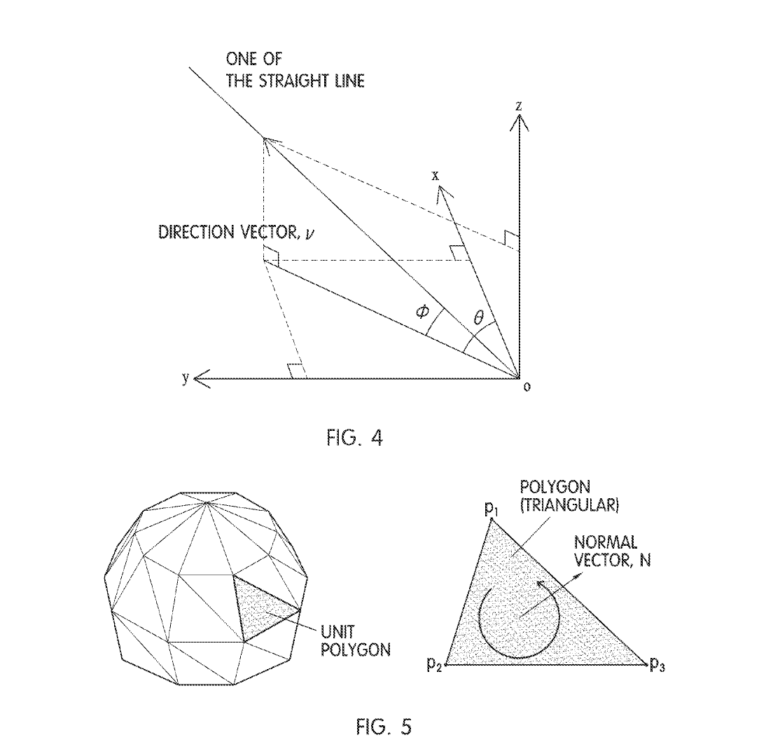

FIG. 5 is a conceptual diagram describing polygon model of a target object.

As illustrated in FIG. 5, the surface of an object may consist of a plurality of triangular polygons, and this is an example of a curved surface being approximated by polygons. If more polygons are used, the surface becomes smoother. The simplest polygon may be a triangle because three points may define a plane. These three points are defined in a global (fixed) coordinate system. If the points are considered as position vectors, a normal vector N of a polygon may be expressed as follows:

\vec{N}=(\vec{p₂}−\vec{p₁})×(\vec{p₃}−\vec{p₁})

The equation of the plane may satisfy the following condition:

\vec{N}·(\vec{p}−\vec{p₁})=0,

where the point p is an arbitrary point on the plane.

Parameter setting unit 110 may set the parameters of the target object described above, but may also receive the parameters of the target object from outside in the form of a computer-aided design (CAD) file. In this case, object parameter setting unit 114 may use the CAD file to set the parameters of the target object.

Referring back to FIG. 1, simulator 120 calculates intersection points of the multiple straight lines of the ultrasound beams with the multiple polygons of the target object or the infinite plane, and derives image data based on the calculated intersection points. Image data is defined as each line's specific information, and for example, includes each line's azimuth angle θ, elevation angle φ, the intersection point's absolute distance, and the intersection point's intensity, whereby sonar image is constructed. The parameters of the infinite plane indicating a background is not relevant to setting of the ultrasound beams or the object and thus may be preset in simulator 120.

Simulator 120 simplify the reflection of the ultrasound beams from the surface of objects by computing an intersection point of a straight line with a polygon, and calculating the absolute distance of the intersection point from origin of the local coordinate system.

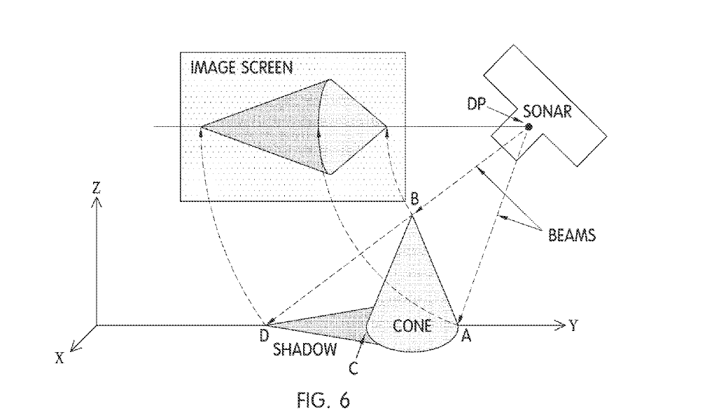

FIG. 6 is a conceptual diagram describing a display mechanism of an imaging sonar.

In FIG. 6, point DP represents a source and sink of ultrasound beams, and an image screen or a sonar image is shown as being rotated by 90° for illustration purposes. Point B is the closest point at which beams can meet so that point B is mapped to the rightmost point in the object region in the sonar image. The right side of the sonar image corresponds to the closer region in distance from the imaging sonar whereas the left side farther region. The beams encounter the target object, for example, at point A which is the bottom of the cone with the greater distance than that of point B, so point A is positioned to the left of point B in the sonar image. The front surface (an area from A to B) of the cone prevents the beams from proceeding and does not meet background until point D. This area is shown as a shadow in the sonar image. The shadow is an area having non-reflected beam data, and is shown in, for example, black in the sonar image.

The imaging sonar is a sensor that can be attached to a ship or an underwater vehicle, so that the imaging sonar may have translation or rotation motion. Thus, to describe the ultrasound beams emitted from the imaging sonar, a local (imaging sonar) coordinate system is defined.

Simulator 120 transforms multiple polygon coordinates, more specifically, the coordinates of polygons' vertices which defined in the global coordinate system into those in the local coordinate system. After the unification of coordinate system simulator 120 can perform the calculation of the intersection points, more specifically, the coordinates of the intersection points of multiple polygons with straight lines.

Computation of the intersection points includes the decision whether a straight line passes any polygons. If the straight line meets any polygon at some point (the intersection point), simulator 120 find the point's coordinate. This computation can be considered as a reflection model of the ultrasound beam.

Calculation of the intersection point may use the following method for efficient calculation because there are a number of polygons and straight lines. For each polygon, the points consisting of the polygon can be described with the azimuth angle and elevation angle in the local coordinate system. Therefore, by setting those coordinates as boundaries, simulator 120 can find the azimuth angle range and elevation angle range that cover the polygon's positional domain. The ranges imply possible and potential angle ranges that some straight lines should belong to in order to meet the polygon. That is, only the straight lines within these ranges are considered to find the intersection points. In this way simulator 120 can select potential straight line candidates for each polygon, and as a result efficiency of computation is increased.

If the intersection point is calculated, a distance from the source, i.e., an origin of the local coordinate system to the intersection point may be calculated, and the distance value may be used to construct a sonar image in such a way the real imaging sonar does.

If one straight line meets two or more polygons and therefore obtain two or more intersection points, simulator 120 select the intersection point that is closest to the origin. In physical interpretation, this practice reflects the fact that ultrasound beam returns right after initial collision.

At this time, the important point is that intersection points should be inside the polygon boundary defined by the polygon vertices.

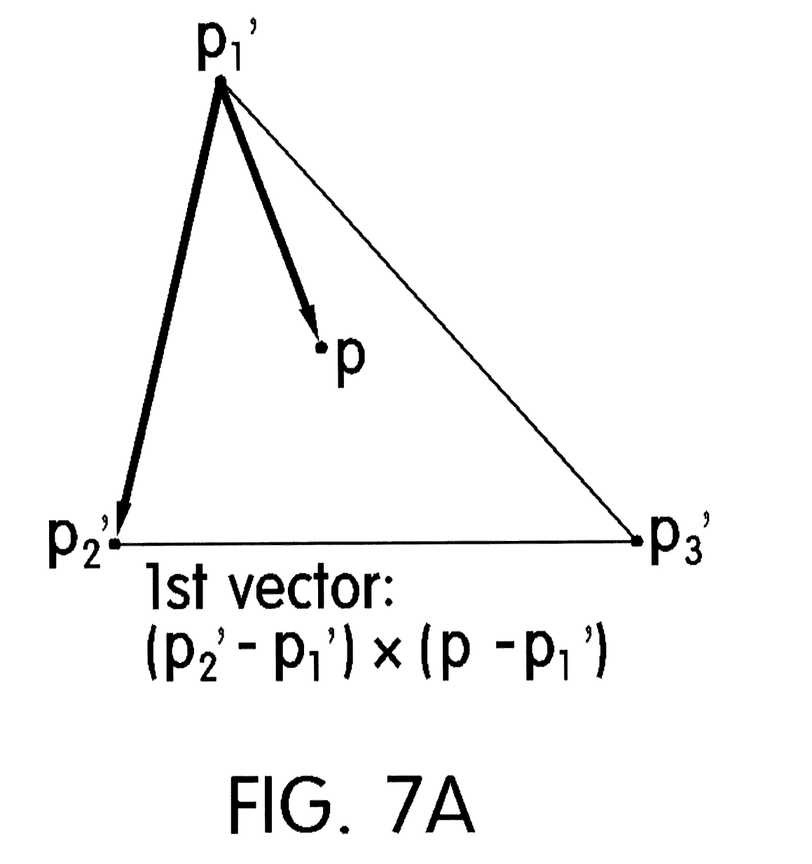

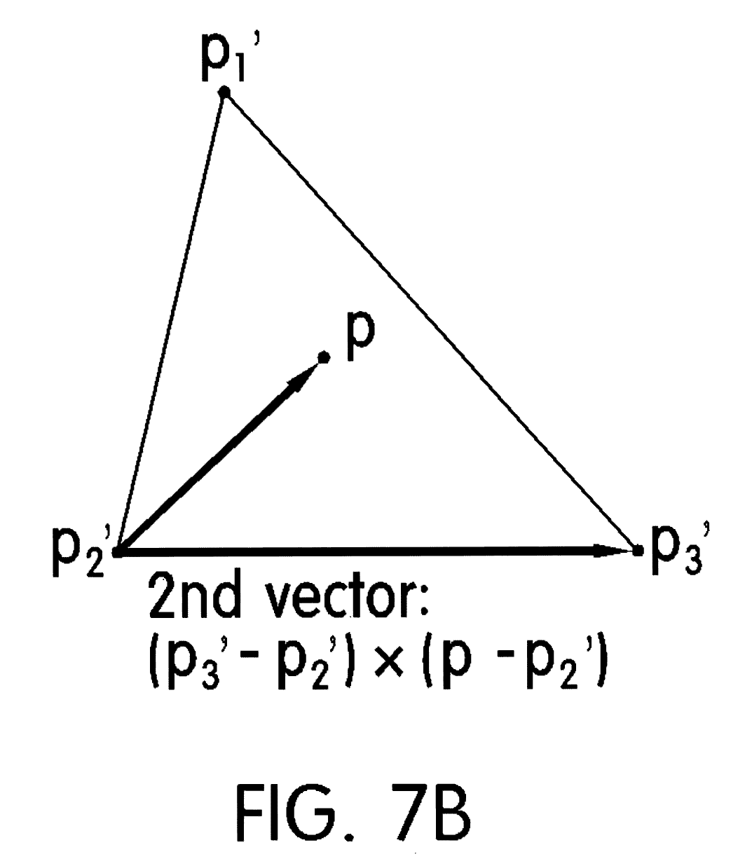

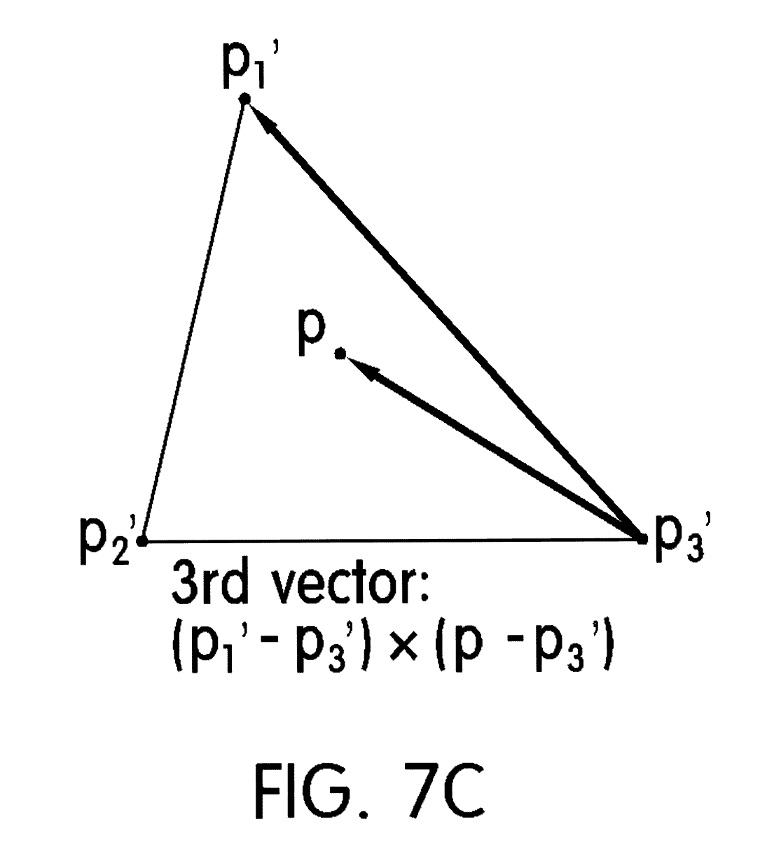

FIGS. 7A through 7C are diagrams illustrating the method of how to choose three vectors to determine whether the intersection point lies in the polygon area. In order for the intersection points to be inside the polygon, the following three equations should be satisfied:

((\vec{p′₂}−\vec{p′₁})×(\vec{p}−\vec{p′₁}))·\vec{N′}≧0

((\vec{p′₃}−\vec{p′₂})×(\vec{p}−\vec{p′₂}))·\vec{N′}≧0

((\vec{p′₁}−\vec{p′₃})×(\vec{p}−\vec{p′₃}))·\vec{N′}≧0

where p₁′, p₂′, p₃′ represent the positions of vertices of the polygon, p the intersection point, and N′ normal vector of the polygon. Once the intersection point is identified inside the polygon, simulator 120 accepts the point validated. Otherwise, simulator 120 ignores the intersection point.

After computing the intersection points for every polygons and straight lines, simulator 120 computes again the intersection points' absolute distance (or Euclidian distance) that is essential component to construct simulated sonar images. The simulator 120 calculates each straight lines' azimuth angle θ, and an elevation angle φ. In this case, the emulator 120 may select a straight line having the higher intensity between two straight lines if two straight lines have the same distance and azimuth angle, but different elevation angles.

Simulator 120 determines an intensity value corresponding to the calculated intersection point depending on type of objects the line meets. For example, simulator 120 may determine the intensity value to be highest if the straight line meets the object polygons; the intensity value to be lowest if the straight line does not meet either the polygon or the infinite plane (shadow case); and the intensity value to be intermediate if the straight line meets the infinite plane representing background. In this way, simulator 120 according to an embodiment of the present invention classifies the intensity values corresponding to the intersection point into three types.

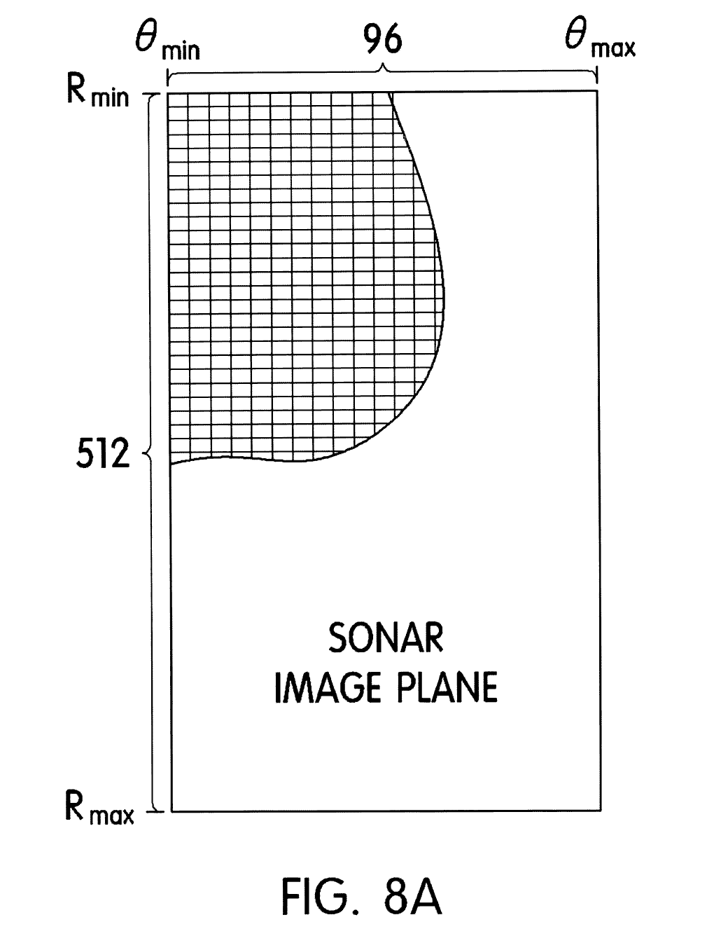

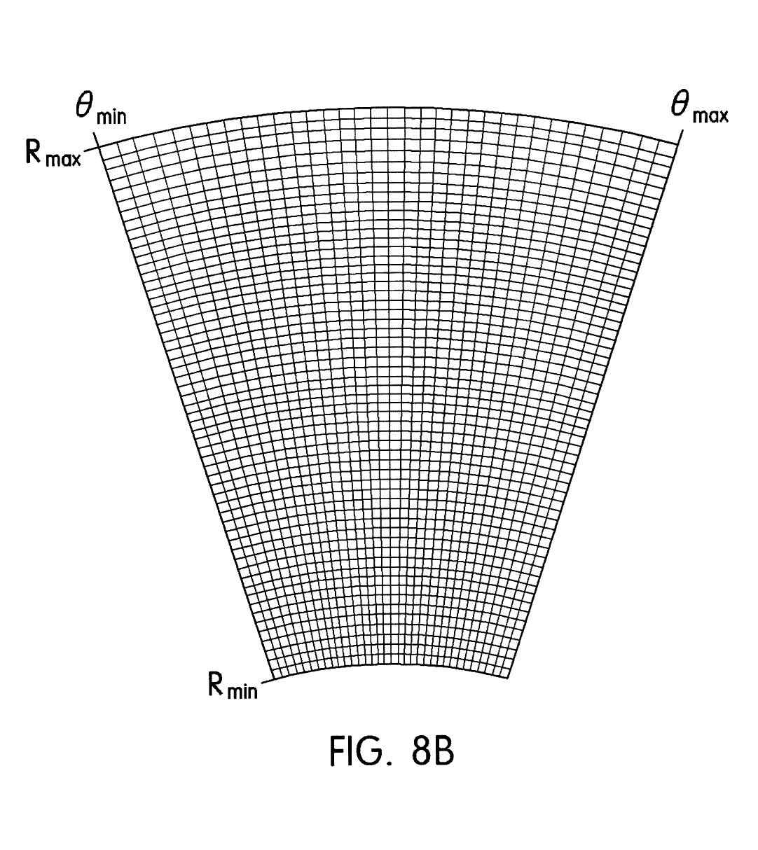

Sonar image constructing unit 130 maps the image data obtained from simulator 120 into an image plane to construct a simulated sonar image. FIGS. 8A and 8B are diagrams illustrating original sonar image form and the transformed sector form.

Sonar image is constructed by referring each line's specific information such as its azimuth angle, the intersection point's absolute distance value, and corresponding intensity value. The sonar image plane consists of two axis indicating azimuth angle (X) and absolute distance (Y) (FIG. 8A). For each and every line, sonar image constructing unit 130 finds the corresponding position in the image plane with reference of azimuth angle and distance value, and set the pixel value in that position to the intensity value.

Referring back to FIG. 1, the sonar-image-simulation apparatus 100 may further include display unit 140 to display the simulated sonar images. Display unit 140 may be, for example, but not limited to, a general display device that can be connected to a computer.

With the above-described structure, the sonar-image-simulation apparatus 100 according to an embodiment of the present invention can simulate any object or underwater environments by constructing simulated sonar images when appropriate 3D models are given. Simulated sonar images have no noise that is inevitable in real sonar images. In addition, the computing efficiency is good enough to be used in a real time basis. These characteristics make prediction of the edge shape of a target object easy.

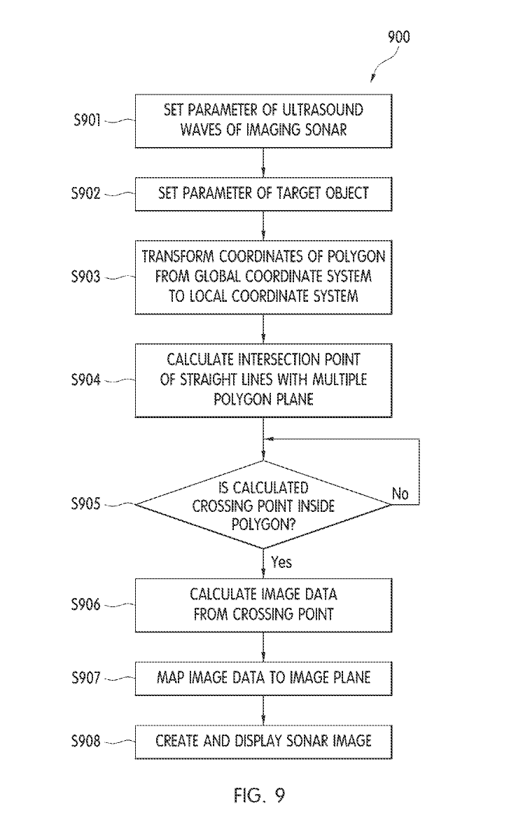

Hereinafter, a sonar-image-simulation method for image prediction of an imaging sonar will be described with reference to FIG. 9. FIG. 9 is a flowchart illustrating the sonar-image-simulation method according to an embodiment of the present invention.

Referring to FIG. 9, the model of ultrasound beams of the imaging sonar is set to multiple straight lines at step S901. As the parameters of the ultrasound beams, the total number of straight lines and their directions and the position and orientation of the imaging sonar may be set. The straight lines indicating the ultrasound beams have elevation angle φ and azimuth angle θ in the local coordinate system, as illustrated in FIG. 4.

Next, the model of the target object is set to multiple polygons at step S902. As the parameters of the model of the target object, the number of polygons and their vertices' coordinate are defined in the global coordinated system. Normally, the parameters of target objects are read from 3D CAD files.

Next, coordinates defining the multiple polygons are transformed from the global coordinate system into the local coordinate system at step S903. It is because the coordinate systems defining the multiple polygons and straight lines are different. By this coordinate system unification, necessary mathematical manipulation can be done.

The intersection points of the straight lines with the multiple polygons or background are calculated at step S904.

At step S905, it is determined whether the obtained intersection point is inside the polygon or polygon boundary; if the intersection point is not inside the polygon, the intersection point is ignored, or if the intersection point is inside the polygon, image data is calculated from the obtained intersection points at step S906.

The calculated image data is mapped to the image plane at step S907 by referring each line's specific information such as its azimuth angle, the intersection point's absolute distance value, and corresponding intensity value. For each and every line, it finds the position corresponding to the line's azimuth angle and distance value in the image plane. In that pixel position, the intensity value is written. The shape of the image plane is transformed into a sector form at step S908. For example, as illustrated in FIG. 8B, the mapped image plane may be transformed into a sector form.

Next, the constructed sonar image is displayed at step S908. The sonar image may be displayed through, but not limited to, a general display device connected to a computer.

The foregoing methods may be implemented by the sonar-image-simulation apparatus 100 as illustrated in FIG. 1, and may be implemented with programs executing the above-described operations, and in this case, these programs may be stored in a computer-readable recording device.

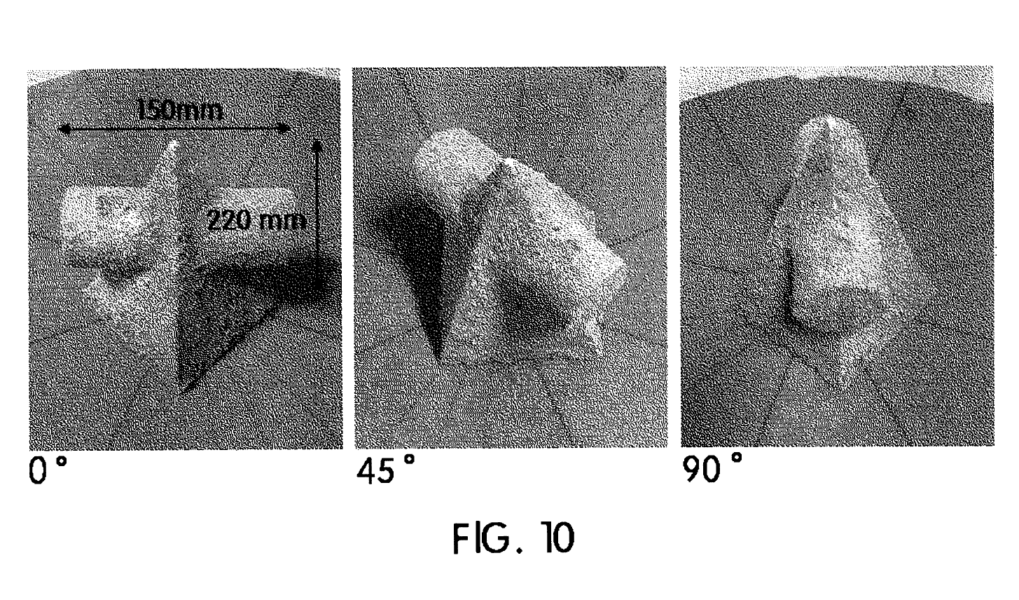

FIG. 10 shows pictures of an exemplary target object used to demonstrate a sonar-image-simulation method for image prediction of an imaging sonar according to an embodiment of the present invention.

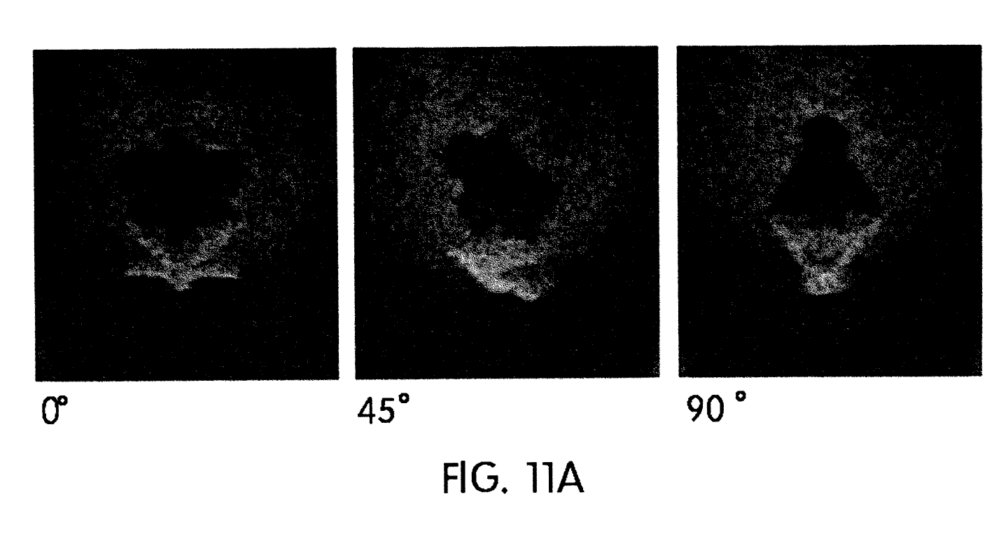

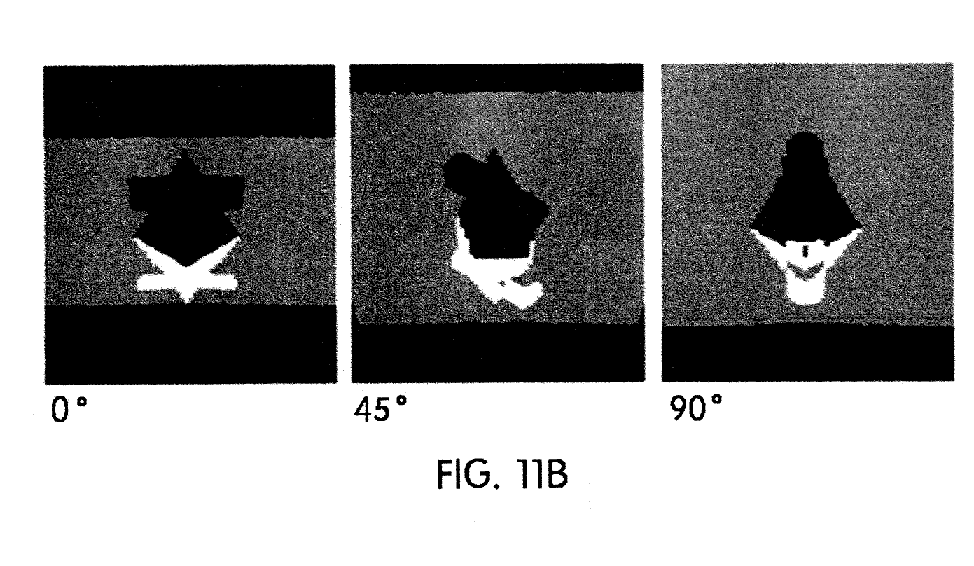

FIGS. 11A and 11B are diagrams illustrating sonar images of the object in FIG. 10 and its corresponding simulated images. As illustrated in FIGS. 11A and 11B, the real sonar images have significant noise while the simulated images do not. Moreover, in the real sonar images, the intensities are not clearly distinguishable between the object and background while the simulated images have clear distinction between them.

Without these differences, the overall shape and size of the target object is very similar in the real sonar image and the simulated images.

As described above, the sonar-image-simulation method and apparatus for image prediction of an imaging sonar can simulate any object or underwater environments by constructing simulated sonar images when appropriate 3D models are given. Simulated sonar images have no noise that is inevitable in real sonar images. In addition, the computing efficiency is good enough to be used in a real-time basis. These characteristics make prediction of the edge shape of a target object easy.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A sonar-image-simulation method for image prediction of an imaging sonar, comprising:
setting a model of ultrasound beams of the imaging sonar, a model of a target object, and a model of a background on which the target object is placed as multiple straight lines, multiple polygons, and an infinite plane, respectively;
simulating image data by calculating intersection points of the multiple straight lines with the multiple polygons or the infinite plane, and deriving the image data based on the calculated intersection points; and
constructing a simulated sonar image by mapping the image data into an image plane.

2. The sonar-image-simulation method of claim 1, wherein the setting comprises:
a first setting of a total number of the straight lines and their directions and a position and an orientation of the imaging sonar as parameters of the model of the ultrasound beams; and
a second setting of multiple polygon meshes as parameters of the model of the target object.

3. The sonar-image-simulation method of claim 2, wherein in the second setting, a shape of the polygons are triangle.

4. The sonar-image-simulation method of claim 1, wherein the setting comprises receiving parameters of the model of the target object in the form of a computer-aided design (CAD) file.

5. The sonar-image-simulation method of claim 1, wherein the simulating comprises:
transforming coordinates of the multiple polygons from a global coordinate system to a local coordinate system;
calculating the intersection points of the multiple straight lines with the coordinate-transformed multiple polygons or the infinite plane; and
calculating the image data depending on a position of the calculated intersection points in the local coordinate system.

6. The sonar-image-simulation method of claim 5, wherein the calculating intersection points comprises determining whether the intersection points are inside the polygons.

7. The sonar-image-simulation method of claim 5, wherein the calculating the image data comprises calculating the intersection point's absolute distance r, and each straight line's azimuth angle θ.

8. The sonar-image-simulation method of claim 7, wherein the calculating the image data comprises selecting a straight line having a higher intensity between two straight lines if the two straight lines have the same distance and azimuth angle but different elevation angles.

9. The sonar-image-simulation method of claim 7, wherein the calculating the image data comprises selecting an intersection point having a smallest distance among two or more intersection points if the two or more intersection points are calculated on one straight line.

10. The sonar-image-simulation method of claim 7, wherein the calculating the image data comprises determining an intensity corresponding to the intersection points according to the type of an object which the straight line meets.

11. The sonar-image-simulation method of claim 10, wherein the calculating the image data comprises determining the intensity to be highest if the straight lines meet the polygons, to be lowest if the straight lines meet neither the polygons nor the infinite plane, and to be intermediate if the straight lines meet the infinite plane.

12. The sonar-image-simulation method of claim 1, further comprising displaying the simulated sonar image.

13. A sonar-image-simulation apparatus for image prediction of an imaging sonar, comprising:
a parameter setting unit for setting: a model of ultrasound beams of the imaging sonar, a model of a target object, and a model of a background on which the target object is placed as multiple straight lines, multiple polygons, and an infinite plane, respectively;
a simulator for calculating intersection points of the multiple straight lines with the multiple polygons or the infinite plane, and deriving the image data based on the calculated intersection points; and
a sonar image constructing unit for constructing a simulated sonar image by mapping the image data into an image plane.

14. The sonar-image-simulation apparatus of claim 13, wherein the parameter setting unit comprises:
an imaging sonar parameter setting unit for setting a total number of the straight lines and their directions and a position and an orientation of the imaging sonar as parameters of the model of the ultrasound beams; and
an object parameter setting unit for setting multiple polygon meshes as parameters of the model of the target object.

15. The sonar-image-simulation apparatus of claim 14, wherein a shape of the polygons are a triangle.

16. The sonar-image-simulation apparatus of claim 13, wherein the parameter setting unit receives parameters of the model of the target object in the form of a computer-aided design (CAD) file.

17. The sonar-image-simulation apparatus of claim 13, wherein the simulator transforms coordinates of the multiple polygons from a global coordinate system to a local coordinate system, calculates the intersection points of the multiple straight lines with the coordinate-transformed multiple polygons or the infinite plane, and calculates the image data depending on a position of the calculated intersection points in the local coordinate system.

18. The sonar-image-simulation apparatus of claim 17, wherein the simulator determines whether the intersection points are inside the polygons.

19. The sonar-image-simulation apparatus of claim 17, wherein the simulator calculates the intersection point's absolute distance r, and each straight line's azimuth angle θ.

20. The sonar-image-simulation apparatus of claim 19, wherein the simulator selects a straight line having a higher intensity between two straight lines if the two straight lines have the same distance and azimuth angle but different elevation angles.

21. The sonar-image-simulation apparatus of claim 19, wherein the simulator selects an intersection point having a smallest distance between two or more intersection points if the two or more intersection points are calculated on one straight line.

22. The sonar-image-simulation apparatus of claim 17, wherein the simulator determines an intensity corresponding to the intersection points according to the type of an object which the straight line meets.

23. The sonar-image-simulation apparatus of claim 22, wherein the simulator determines the intensity to be highest if the straight lines meet the polygons, to be lowest if the straight lines meet neither the polygons nor the infinite plane, and to be intermediate if the straight lines meet the infinite plane.

24. The sonar-image-simulation apparatus of claim 13, further comprising a display unit for displaying the simulated sonar image.
